(19) United States
(12) Patent Application Publication
(10) Pub. No.: US 2016/0149438 A1
(43) Pub. Date: May 26, 2016

(54) POWER SUPPLY SYSTEM

(71) Applicant: HON HAI PRECISION INDUSTRY CO., LTD., New Taipei (TW)

(72) Inventor: HSIANG-PIN TSENG, New Taipei (TW)

(21) Appl. No.: 14/591,460

(22) Filed: Jan. 7, 2015

(30) Foreign Application Priority Data
Nov. 26, 2014 (TW) 103140920

(51) Int. Cl. H02J 9/06; H02J 1/00; H02J 7/00

(52) U.S. Cl. CPC H02J 9/06; H02J 7/0052; H02J 7/007; H02J 1/00

(57) ABSTRACT

A power supply system includes a battery, a controller, and an adaptor. A power supply is configured to supply power to an electronic device. The controller includes a detecting module, a comparison module, and a control module. The detecting module is configured to detect working status of the electronic device. The comparison module is configured to compare a capacity of the adaptor with a load. The control module is configured to determine a supply status of the adaptor, control the adaptor to output a first charging current to charge the battery when the adaptor is normal supply status, the capacity of the adaptor is greater than the load, and the electronic device is normal, and control the adaptor to output a second charging current to charge the battery when the adaptor is the normal supply status and the electronic device is in a stand-by mode.

### CROSS-REFERENCE TO RELATED APPLICATIONS

This application claims priority to Taiwanese Patent Application No. 103140920 Nov. 26, 2014, the contents of which are incorporated by reference herein.

### FIELD

The subject matter herein generally relates to a power supply system.

### BACKGROUND

A power supply system in a notebook computer may be used to charge a battery.

### BRIEF DESCRIPTION OF THE DRAWINGS

Implementations of the present technology will now be described, by way of example only, with reference to the attached figures.

FIG. 1 is a block diagram of one embodiment of a power supply system.

FIG. 2 is a table of one embodiment of the power supply system, showing a supply status of an adaptor.

FIGS. 3 and 4 illustrate a flowchart of one embodiment of the power supply system, showing a capacity of the adaptor is not less than a load.

FIGS. 5 and 6 are similar to FIGS. 3 and 4, but show the capacity of the adaptor as less than a load.

FIGS. 7 and 8 are similar to FIGS. 3 and 4, but show the supply status of the adaptor.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a power supply system to charge a battery.

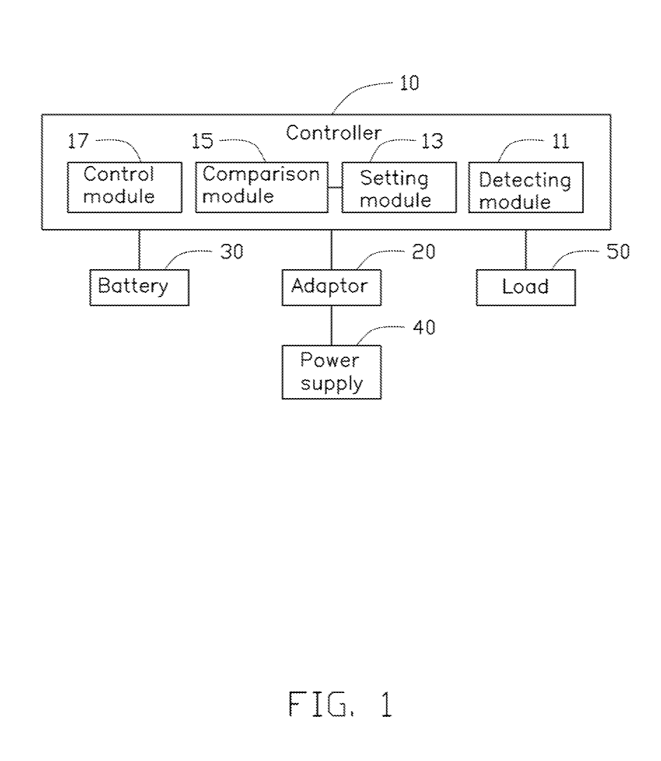

FIG. 1 illustrates an embodiment of a power supply system. The power supply is used in an electronic device and comprises a controller 10, an adaptor 20, and a battery 30. The adaptor 20 is coupled to a power supply 40. In one embodiment, the electronic device is a computer. The power supply 40 is configured to supply power to a load 50 of the computer and charge the battery 30 via the adaptor 20. The controller 10 comprises a detecting module 11, a setting module 13, a comparison module 15, and a control module 17.

The detecting module 11 is configured to detect a working status of the computer, detect a capacity of the adaptor 20, determine whether the battery 30 exists, and detect the load 50. The working status of the computer comprises a normal status (S0 status) and a stand-by. The stand-by comprises a S3 status, a S4 status and a S5 status. The setting module 13 is configured to set a first reference value and a second reference value. The comparison module 15 is configured to compare the capacity of the adaptor 20 with the load 50. The comparison module 15 is also configured to compare the capacity of the adaptor 20 with a capacity of the battery 30. The control module 17 is configured to determine a supply status of the adaptor 20 and determine to supply power to the power supply according to the adaptor 20 and the load 50. The supply status of the adaptor 20 comprises a normal supply status, an electricity shortage status, and an abnormal supply status.

The control module 17 determines the adaptor 20 is normal supply when the capacity of the adaptor 20 is not less than the load 50, determines the adaptor 20 is electricity shortage when a difference value between the capacity of the adaptor 20 and the load 50 is not greater than the first reference value, and determines the adaptor 20 is abnormal supply when the difference value is greater than the first reference value and not less than the second reference value.

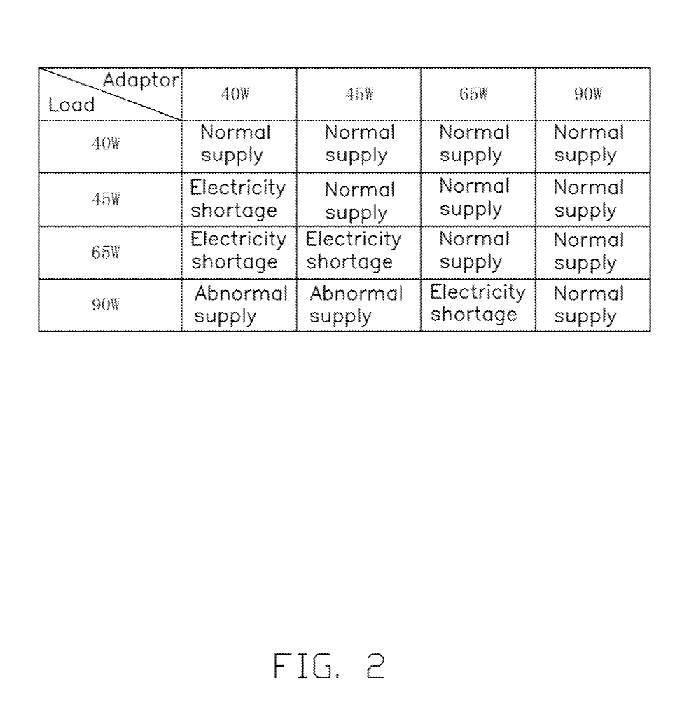

FIG. 2 illustrates that in one embodiment, when the capacity of the adaptor 20 is 40 W and the load 50 is 40 W, 45 W, 65 W, and 90 W, the controller 10 determines the adaptor 20 is normal supply; when the capacity of the adaptor 20 is 45 W and the load 50 is 40 W, the controller 10 determines the adaptor 20 is electricity shortage; when the capacity of the adaptor 20 is 45 W and the load 50 is 45 W, 65 W, and 90 W, the controller 10 determines the adaptor 20 is normal supply; when the capacity of the adaptor 20 is 65 W and the load 50 is 40 W and 45, the controller 10 determines the adaptor 20 is electricity shortage; when the capacity of the adaptor 20 is 65 W and the load 50 is 65 W and 90 W, the controller 10 determines the adaptor 20 is normal supply; when the capacity of the adaptor 20 is 90 W and the load 50 is 40 W and 45, the controller 10 determines the adaptor 20 is abnormal supply; when the capacity of the adaptor 20 is 90 W and the capacity of the adaptor 20 is 65 W, the controller 10 determines the adaptor 20 is electricity shortage; the controller 10 determines the adaptor 20 is normal supply; and when the capacity of the adaptor 20 is 90 W and the load 50 is 90 W, the controller 10 determines the adaptor 20 is normal supply.

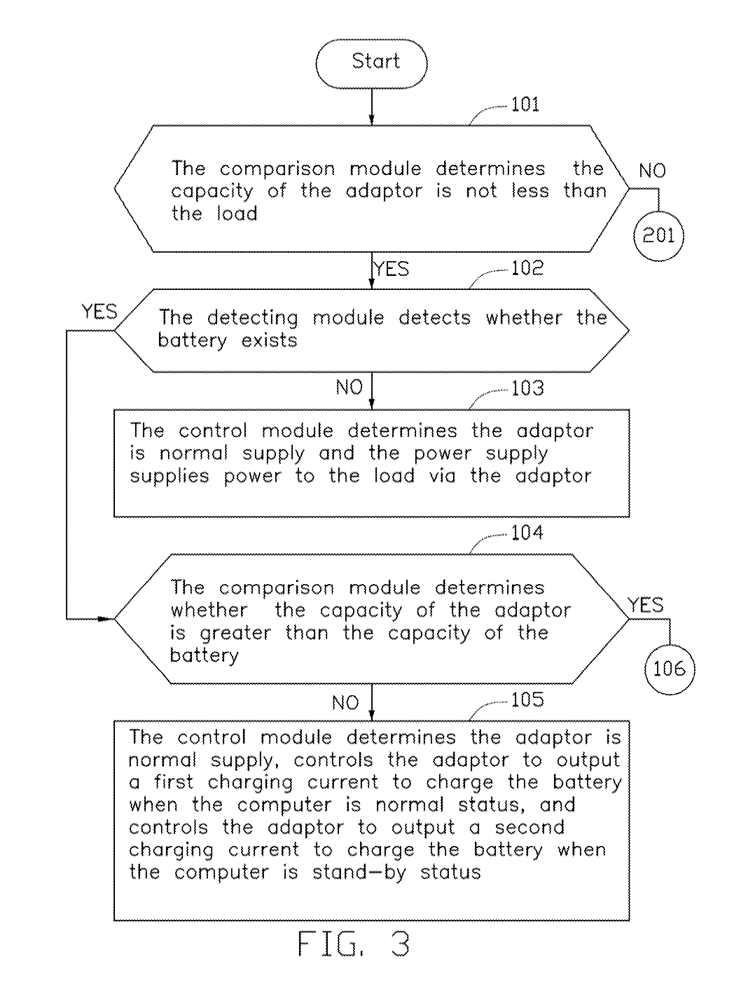

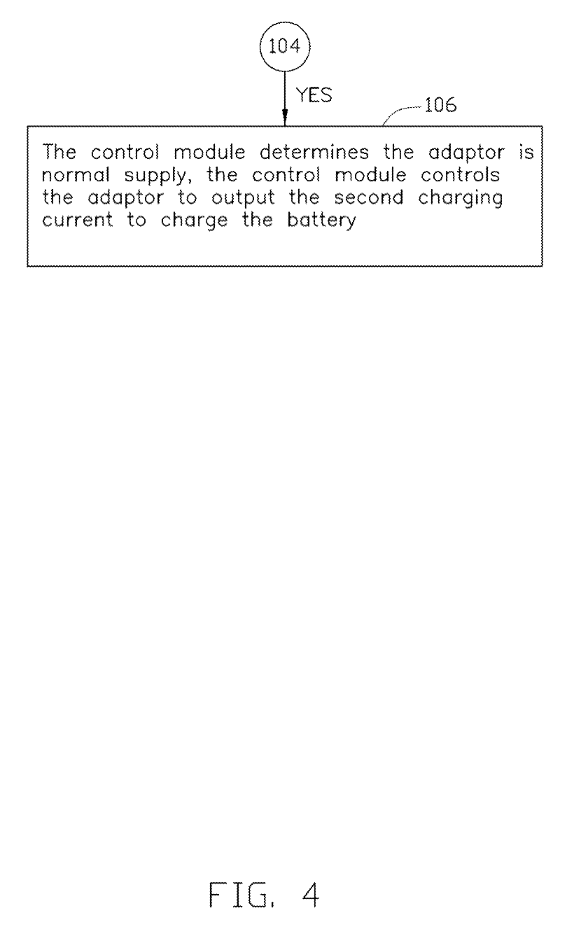

FIGS. 3 and 4 illustrate a flowchart in accordance with an example embodiment. A method of the power supply system is provided by way of example, as there are a variety of ways to carry out the method. The method of the power supply system described below can be carried out using the configurations illustrated in FIG. 1, for example, and various elements of these figures are referenced in explaining method of the power supply system. In FIGS. 3 and 4 each block represents one or more processes, methods, or subroutines carried out in the voice-recognition method. Additionally, the illustrated order of blocks is by example only and the order of the blocks can change. The method of the power supply system can begin at block 101.

At block 101, the comparison module 15 determines whether the capacity of the adaptor 20 is not less than the load 50, if yes, the method goes to block 102; if no, the method goes to block 201.

At block 102, the detecting module 11 detects whether the battery 30 exists, if no, the method goes to block 103; if yes, the method goes to block 104.

At block 103, the control module 17 determines the adaptor 20 is normal supply and the power supply 40 supplies power to the load 50 via the adaptor 20.

At block 104, the comparison module 15 determines whether the capacity of the adaptor 20 is greater than the capacity of the battery 30, if no, the method goes to block 105; if yes, the method goes to block 106.

At block 105, the control module 17 determines the adaptor 20 is normal supply, controls the adaptor 20 to output a first charging current to charge the battery 30 when the computer is normal status, and controls the adaptor 20 to output a second charging current to charge the battery 30 when the computer is stand-by.

At block 106, the control module 17 determines the adaptor 20 is normal supply, the control module 17 controls the adaptor 20 to output the second charging current to charge the battery 30.

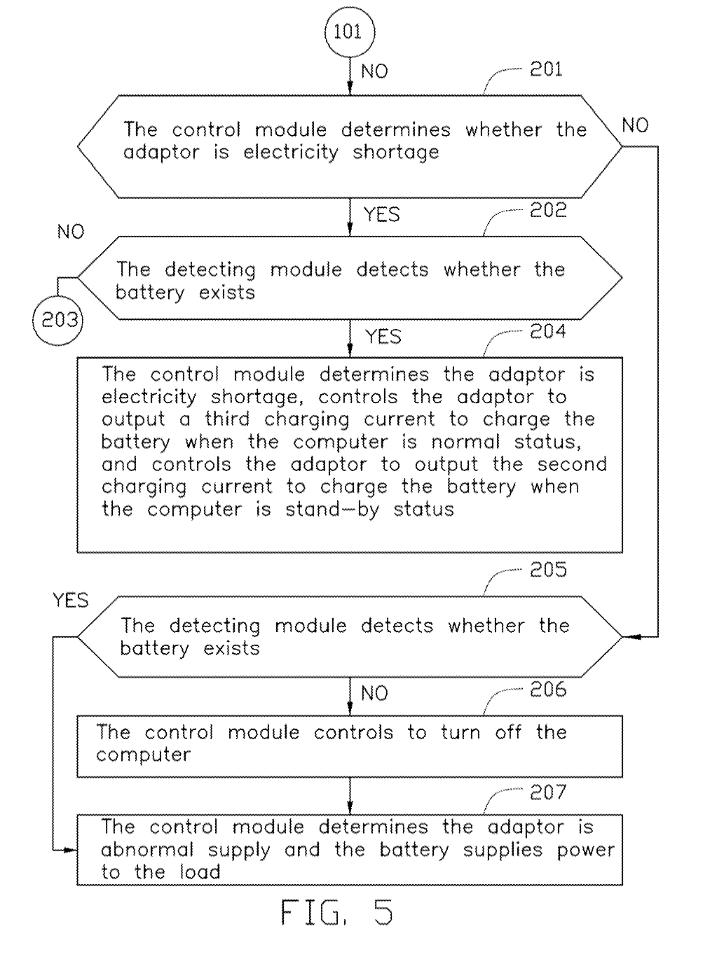

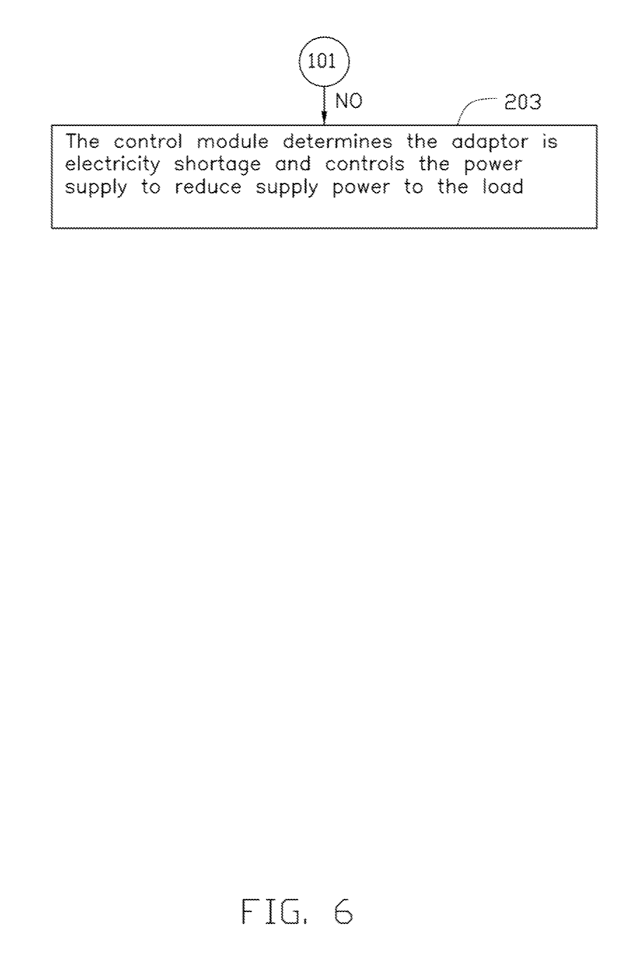

FIGS. 5 and 6 illustrate a flowchart in accordance with an example embodiment. A method of the power supply system is provided by way of example, as there are a variety of ways to carry out the method. The method of the power supply system described below can be carried out using the configurations illustrated in FIG. 1, for example, and various elements of these figures are referenced in explaining method of the power supply system. In FIGS. 5 and 6 each block represents one or more processes, methods, or subroutines carried out in the voice-recognition method. Additionally, the illustrated order of blocks is by example only and the order of the blocks can change. The method of the power supply system can begin at block 201.

At block 201, the control module 17 determines whether the adaptor 20 is electricity shortage, if yes, the method goes to block 202; if no, the method goes to block 205.

At block 202, the detecting module 11 detects whether the battery 30 exists, if no, the method goes to block 203; if yes, the method goes to block 204.

At block 203, the control module 17 determines the adaptor 20 is electricity shortage and controls the power supply 40 to reduce power to the load 50.

At block 204, the control module 17 determines the adaptor 20 is electricity shortage, controls the adaptor 20 to output a third charging current to charge the battery 30 when the computer is normal status, and controls the adaptor 20 to output the second charging current to charge the battery 30 when the computer is stand-by.

At block 205, the detecting module 11 detects whether the battery 30 exists, if no, the method goes to block 206; if yes, the method goes to block 207.

At block 206, the control module 17 controls to turn off the computer.

At block 207, the control module 17 determines the adaptor 20 is abnormal supply and the battery 30 supplies power to the load 50.

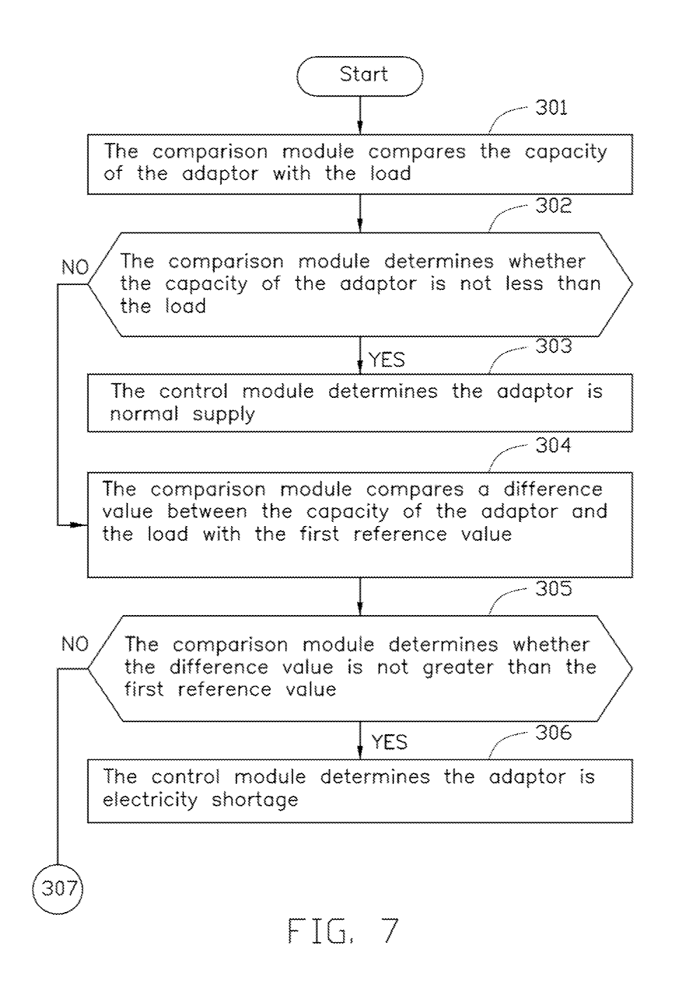

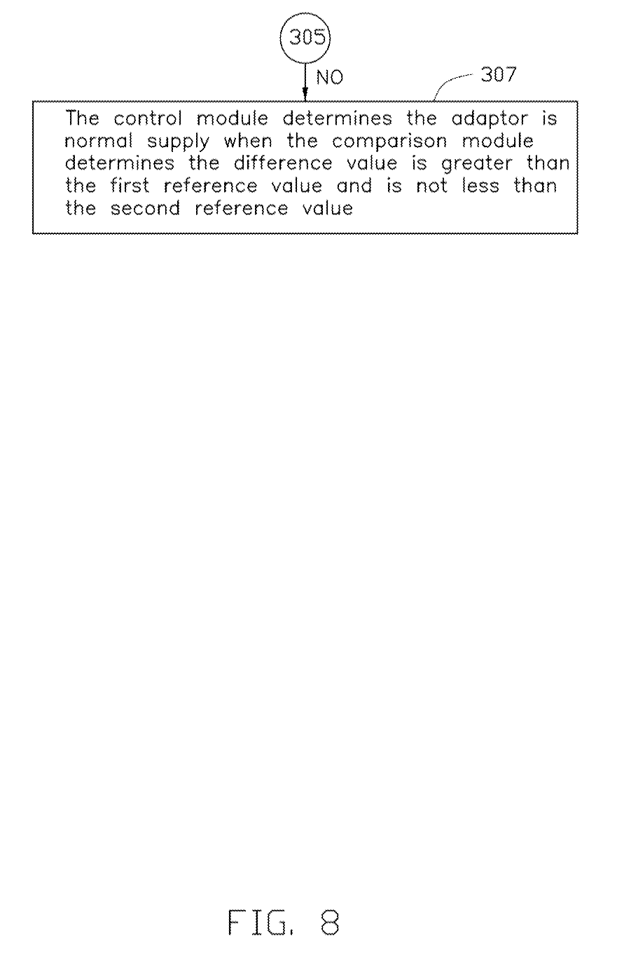

FIGS. 7 and 8 illustrate a flowchart in accordance with an example embodiment. A method of the power supply system is provided by way of example, as there are a variety of ways to carry out the method. The method of the power supply system described below can be carried out using the configurations illustrated in FIG. 1, for example, and various elements of these figures are referenced in explaining method of the power supply system. In FIGS. 7 and 8 each block represents one or more processes, methods, or subroutines carried out in the voice-recognition method. Additionally, the illustrated order of blocks is by example only and the order of the blocks can change. The method of the power supply system can begin at block 301.

At block 301, the comparison module 15 compares the capacity of the adaptor 20 with the load 50.

At block 302, the comparison module 15 determines whether the capacity of the adaptor 20 is not less than the load 50, if yes, the method goes to block 303; if no, the method goes to block 304.

At block 303, the control module 17 determines the adaptor 20 is normal supply.

At block 304, the comparison module 15 compares a difference value between the capacity of the adaptor 20 and the load 50 with the first reference value.

At block 305, the comparison module 15 determines whether the difference value is not greater than the first reference value, if yes, the method goes to block 306; if no, the method goes to block 307.

At block 306, the control module 17 determines the adaptor 20 is electricity shortage.

At block 307, the control module 17 determines the adaptor 20 is normal supply when the comparison module 15 determines the difference value is greater than the first reference value and is not less than the second reference value.

In the power supply system, the controller 10 compares the capacity of the adaptor 20 with the load 50 and outputs different charging current to supply power to the battery 30. In one embodiment, the second charging current is greater than the first charging current and the first charging current is greater than the third charging current.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A power supply system comprising:
a battery;
a controller comprising:
a detecting module,
a comparison module, and
a control module; and
an adaptor couplable to a power supply;
wherein the power supply is configured to supply power to an electronic device via the adaptor;
wherein the detecting module is configured to detect a working status of the electronic device;
wherein the comparison module is configured to compare a capacity of the adaptor with a load;
wherein the comparison module is further configured to compare the capacity of the adaptor with a capacity of the battery,
wherein the control module is configured to determine a supply status of the adaptor;
wherein when the adaptor is in a normal supply status, the capacity of the adaptor is greater than the load, the electronic device is in a normal status, and the control module controls the adaptor to output a first charging current to charge the battery; and
when the adaptor is the normal supply status and the electronic device is in a stand-by mode, the control module controls the adaptor to output a second charging current to charge the battery.

2. The power supply system of claim 1, wherein when the adaptor is normal supply and the capacity of the adaptor is not greater than a capacity of the battery, the control module is also configured to control the adaptor to output a second charging current to charge the battery.

3. The power supply system of claim 1, wherein the control module determines the adaptor is normal supply when the capacity of the adaptor is not less than the load.

4. The power supply system of claim 1, wherein the comparison module configured to compare a difference value between the capacity of the adaptor and the load with the first reference value, and the control module determines the adaptor is electricity shortage when the difference value is not greater than the first reference value.

5. The power supply system of claim 4, wherein the control module determines the adaptor is abnormal supply when the comparison module determines the difference value is greater than the first reference value and is not less than the second reference value.

6. The power supply system of claim 5, wherein the control module controls the battery to supply power to the computer when determining the adaptor is abnormal supply and the battery exists.

7. The power supply system of claim 4, wherein the control module controls the adaptor to output a third charging current to charge the battery when the adaptor is electricity shortage and the computer is normal status, and the control module controls the adaptor to output the second charging current to charge the battery when the adaptor is electricity shortage and the electronic device is in the stand-by mode.

8. The power supply system of claim 7, wherein the second charging current is greater than the first charging current.

9. The power supply system of claim 4, wherein the controller further comprises a setting module and the setting module is configured to set the first reference value.

10. The power supply system of claim 1, wherein the second charging current is greater than the first charging current.

11. A power supply system comprising:
a battery;
a controller comprising:
a detecting module, and
a control module; and
an adaptor couplable to a power supply;
wherein the power supply is configured to supply power to an electronic device via the adaptor;
wherein the detecting module is configured to detect a working status of the electronic device;
wherein the control module is configured to determine a supply status of the adaptor;
wherein the control module is configured to control the adaptor to output a first charging current to charge the battery when the adaptor is electricity shortage and the battery exists, and the electronic device is in a normal status; and
when the adaptor is electricity shortage and the battery exists, and the electronic device is in a stand-by mode, the control module is configured to control the adaptor to output a second charging current to charge the battery.

12. The power supply system of claim 11, wherein the controller further comprises a comparison module, the comparison module is configured to compare a capacity of the adaptor with the load, and the control module is configured to determine the adaptor determines the adaptor is electricity shortage when a difference value between the capacity of the adaptor and the load is not greater than a first reference value.

13. The power supply system of claim 12, wherein the control module is configured to determine the adaptor is normal supply when the capacity of the adaptor is not less than the load, and control the adaptor to output a third charging current to charge the battery when the adaptor is the normal supply status and the electronic device is in the normal status.

14. The power supply system of claim 13, wherein the third charging current is greater than the first charging current.

15. The power supply system of claim 13, wherein the comparison module is configured to compare the capacity of the adaptor with a capacity of the battery, the control module is configured to determine the adaptor is normal supply when the capacity of the adaptor is not greater than the capacity of the battery.

16. The power supply system of claim 15, wherein the control module is further configured to control the adaptor to output the third second charging current to charge the battery when the adaptor is the normal supply status and the electronic device is the stand-by mode.

17. The power supply system of claim 13, wherein the control module determines the adaptor is abnormal supply when the comparison module determines the difference value is greater than the first reference value and is not less than a second reference value.

18. The power supply system of claim 17, wherein the control module controls the battery to supply power to the computer when determining the adaptor is abnormal supply and the battery exists.

19. The power supply system of claim 17, wherein the controller further comprises a setting module and the setting module is configured to set the second reference value.

20. The power supply system of claim 11, wherein the second charging current is less than the first charging current.
